(19) United States
(12) Patent Application Publication
(10) Pub. No.: US 2022/0097253 A1
(43) Pub. Date: Mar. 31, 2022

(54) ALDEHYDE TREATMENT OF LUMBER

(71) Applicant: Finoric, LLC, Beasley, TX (US)

(72) Inventors: Deepak PATIL, Friendswood, TX (US); Ambrish Kamdar, Beasley, TX (US)

(73) Assignee: Finoric, LLC, Beasley, TX (US)

(21) Appl. No.: 17/486,522

(22) Filed: Sep. 27, 2021

Related U.S. Application Data
(60) Provisional application No. 63/083,574, filed on Sep. 25, 2020.

(51) Int. Cl. B27K 3/34; B27K 3/02

(52) U.S. Cl. CPC B27K 3/343; B27K 2240/20; B27K 3/02

(57) ABSTRACT

A wood treatment method for reducing fungal growth utilizes a treatment solution comprising an aldehyde, a carrier solvent, an organic co-solvent, at least one surfactant, and at least one acid, base, or salt. In embodiments, the carrier solvent may comprise water and the organic co-solvent may comprise an alcohol or acetone. The aldehyde is impregnated into the wood, where it reacts with thiamine and other amino acids to promote cross-linking, reducing the porosity of the wood and thereby reducing the ability of various microbes and fungi to access the interior of the wood as a nutrient source.

### REFERENCE TO RELATED APPLICATIONS

This is a utility patent application claiming priority to U.S. Provisional application No. 63/083,574, filed on 25 Sep. 2020, also titled “Aldehyde Treatment of Lumber” and having the same inventors. The contents are accordingly incorporated by reference.

### FIELD

The invention is in the field of lumber treatment with a view towards providing resistance to decay, mold, mildew, and other biological growths.

### BACKGROUND

The production of lumber and wood composite products has increased dramatically in recent years. Oriented Strand Board (OSB) production exceeded that of plywood in 2000. The use of medium density fiberboard and hardboard panel products likewise has increased dramatically over the last couple of decades. However, wood and wood based materials are susceptible to biological attack by microorganisms, especially fungal attack. Biological attack can result in cosmetic damage, structural degradation and presents a human health hazard when wood and wood composite products are used indoors.

Preservatives are used to treat wood to resist microbial attack and decay. The commercially used preservatives are separated into three basic categories, based primarily on the mode of application-waterborne, creosote, and oil borne preservatives. Waterborne preservatives include chromated copper arsenate (CCA), ammoniacal copper quat (ACO), which is believed to be copper-MEA-carbonate and a quaternary amine, ammoniacal copper zinc arsenate (ACZA), and ammoniacal copper arsenate (ACA). Wood treated with these chemicals, sometimes turns green or grey-green because of a chemical reaction between copper in the preservative and the sun's ultraviolet rays. The preservatives leach into the soil over time, especially those made without chromium, when exposed to weather. Creosote does not easily leach into soil, and it is not corrosive to metals, but it cannot be painted and it leaves a dark, oily surface that has a strong odor. Oil borne preservatives are made of certain compounds dissolved in light petroleum oils, including pentachlorophenol (commonly known as “penta”), copper naphthenate, and copper-8-quinolinolate. These preservatives leave a surface that often is non-paintable, and the surface of the wood can be dark and unnaturally colored.

Development of methods for preservation treatment of wood has increased usefulness of wood as a structural material for construction such as walls, flooring and the like. The preservation treatment is generally carried out by dipping wood in a preservative solution, predominantly biocides and fungicides, accompanied by vacuum impregnation and/or pressure impregnation. It is, however, difficult to produce uniformly treated wood because of differences in the rate of penetration of a preservative between two parts of the main stem of a tree, i.e., the outer part (sapwood portion) and the inner core (heartwood portion).

Penetration of preservative may be improved by incising, i.e., by mechanically making spaced slit like cuts in the outer layer of wood with an incising machine. The incising is not so effective for large logs or square timber of with large size as it can only provide shallow holes. Since the heartwood is generally penetrated with the preservative at a low rate as compared with the sapwood, the preservation treatment of heartwood takes a long period of time even if the wood to be treated has been incised before preservation treatment.

The preservation treatment of wood is generally accomplished by artificial drying procedures such as heating the wood with steam or hot air typically in a kiln, and dielectric heating resulting from application of high frequency waves, to finish the drying process within a short time. The artificial procedures increase the rate of drying as compared with natural air drying, but there are some problems awaiting a solution. For example, the steam or hot-air drying is accompanied by rapid surface drying, and heating due to conduction of heat, so that the water in the outer portion of the wood is discharged easily by evaporation. However, the moisture movement in the inner portion is very low as compared with that in the outer portion, so that a difference in the moisture content between the outer and inner portions of the wood is produced during drying, which may cause surface cracking, inter checks or other defects during drying process, and by twist, crook cupping and other defects after drying. To avoid these problems, it is required to lower the rate of drying, thus making it difficult to reduce the time for drying.

R. K. Grover in discloses the fungigenic properties of amino acids in “The effect of amino acids on growth and sporulation of Aspergillus flavus and their carry-over for subsequent spore germination” (Department of Botany, Panjab University, Chandigarh, India, 5 Apr. 1963). Aspergillus flavus utilized amino nitrogen source better than nitrate, nitrite, or ammonium nitrogen sources. With casein hydrolysate as nitrogen source, optimum growth was obtained at 100 micrograms N/nil concentration when incubated for 8 days at 24-26 deg C. Using ten different amino acids singly or in mixture in Czapek's synthetic basal medium at a concentration of 100 micrograms N/ml, the mycelial yields were higher when the basal medium contained L-arginine, glycine, DL-leucine, DL-methionine or the mixture of ten amino acids, than when casein hydrolysate was used. Abundant sporulation was obtained when the basal medium contained glycine, DL-leucine, or DL-methionine. It proves that amino acid and nitrogen containing compounds and similar amino compounds are a good nutrition source for the fungi. By extension, proteins held within the wood are a group of amino acid and nitrogen containing compounds which can also serve as a food source for such microbes.

Darrel Nicholas discloses the effect of thiamine and similar nitrogenous compounds on fungal growth in “Wood deterioration and its prevention by preservative treatment” (Vol 1, Syracuse University Press, 1973).

Simon Pepin discloses an example of fungicidally-treated wood in “Characterization of diffusion of organic fungicides with amine oxides in white pipe and white spruce” (BioRes, 15(1), 1026-1049), impregnation of propiconazole and iodopropylbutylcarbamate fungicides was enhanced with surfactants such as dimethylhexadecylamineoxide which also may possess limited antiseptic properties.

RA Hill, WO1995007807A2, discloses effect of various terpenes on resisting the sapstain fungal attack on wood. But, the performance of these terpenes is compromised when administered as emulsions or in lower concentration. Although the terpenes coating may prevent fungal attack, they will also prevent the drying of the wood.

Peter Vinden, U.S. Pat. No. 6,742,278 B2, discloses importance of increasing permeability of wood to permit better contact of biocides, the same process also permits increased penetration of fungi. Alan Ross, U.S. Pat. No. 7,056,919 B2, discloses use of multiple biocides to synergistically protect the wood from microbes. Dian-Quian Yang, U.S. Pat. No. 6,083,537, discloses using biocides at higher pH with the use of sodium bicarbonate and carbonate to protect the wood from sapstain fungi.

Kapil Girotra, U.S. Pat. No. 9,393,762 B2, discloses use of acetic acid and acetic anhydride to react with the wood and change the molecular structure of cellulose. Any other anhydrides will similarly react with cellulose. The anhydrides will also react with water in the wood thus producing free acid.

Danny Elder, U.S. Pat. No. 6,014,819, discusses about the importance of removing moisture as rapidly as possible. The process required wood treatment at higher temperature in specially constructed boxes and then cooled slowly with low humidity air. This is not easily practiced or practical at tens of thousands of sawmills which simply dip the wood in various treatment solutions and stack them to air dry for 10-12 weeks.

J R Felty, US 2016/0354948 A1, DG Miller, U.S. Pat. No. 3,721,013, and B G Iverlund, U.S. Pat. No. 4,485,564, disclose process for microwave treatment of green wood to remove moisture as rapidly as possible. Again, this is not easily practiced or practical at tens of thousands of sawmills which simply dip the wood in various treatment solutions and stack them to air dry for 10-12 weeks.

H. Wayne Richardson, US 2004/0258768A1, discloses use of copper salts as a biocide. However, copper salts slowly change the color of the wood to various shades of green.

### SUMMARY

The invention described herein relates to an aldehyde containing treatment for wood products which makes wood products resistant to fungal growth. To perform the aldehyde treatment, wood is dipped in or sprayed on with a formulation containing an aldehyde compound. This aldehyde containing treatment comprises an aldehyde chemical compound, a carrier solvent (e.g., water), an organic co-solvent (e.g., alcohol, acetone), at least one surfactant, and at least one acid, base, or salt (i.e., an ionic compound). The aldehyde is present at between 0.01 wt % and 10 wt %, the organic co-solvent at between 0.001 wt % and 40 wt %, the surfactant at between 0.001 wt % and 10 wt %, and the acid, base, or salt at between 0.001 wt % and 10 wt %. Other embodiments may comprise a biocide compound, or other functional additives such as pH buffers, adhesives, iron stain inhibitors, corrosion inhibitors, emulsifiers, fillers, viscosity regulators, binders, tackifiers, or combinations thereof. The aldehyde may comprise an aldehyde precursor reacting to form the aldehyde in situ.

In an embodiment, the wood may be treated by spraying or brushing with the treatment mixture, or it may be immersed in a bath or dip tank, and dried at 200° C. or below. The aldehyde reacts with the amino groups of natural proteins and amino acid and nitrogen containing compounds in the wood such as thiamine as it moves into the porous media. Condensation of the aldehyde and amino groups leads to cross linking of these amino groups and creates a bulkier molecule which reduces the porosity of the wood. Reducing the porosity of the wood by cross-linking of the amino groups also reduces the access to various biological agents to these amino group bearing compounds as food source.

### DRAWINGS

FIG. 1 shows the thiamine molecule.

FIG. 2 shows the reaction scheme which alters the thiamine.

### DETAILED DESCRIPTION

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of chemical equivalents may be made without departing from the spirit of the invention.

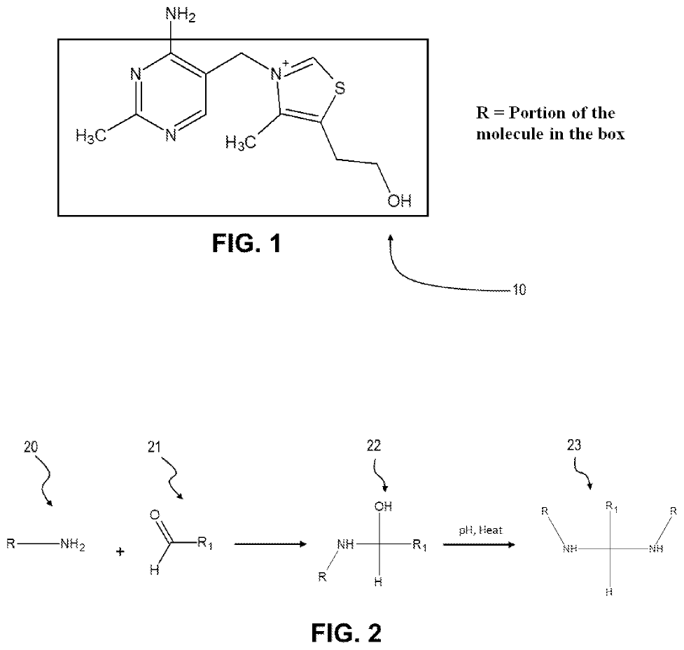

Turning first to FIG. 1, in the case of thiamine, the amino group in the 4 position of the pyrimidine portion of the molecule 10 reacts with the carbonyl group of the aldehyde easily, thus converting the thiamine into a molecule that is not easily available to the fungi.

Turning now to FIG. 2, the reaction scheme of the invention is shown in which the amine group 20 reacts with the aldehyde 21. Parameters affecting the reaction include pH, temperature, and concentration. The methylol is easily made as the first intermediate 22. The intermediate methylol is converted to the diamine 23 and this reaction is promoted by lower pH, higher temperature and higher concentration.

For some uses, it is desirable to treat porous materials like wood with less aldehyde. It has been found that lower concentrations of the aldehyde condensate in the wood will still provide useful properties at lower cost and less change in porosity.

A method of controlling the concentration of aldehyde in the porous material is to use a liquid carrier for the aldehyde. The carrier and the aldehyde enter in the porous material together. The carrier is removed from the porous material after evaporation, leaving the aldehyde promoting the cross-linking and condensation reactions with the amino groups in place within the porous material. Hardwood lumber, softwood lumber, oriented strand board, and other such wood or wood-based products are the principal objects of this invention.

Water is an environmentally friendly, inexpensive compound. Certain aldehydes are soluble in water, so water can be used as a carrier for diluted aldehydes.

Other useful chemicals to stabilize and promote absorption of the aldehydes into the porous wood are surfactants. Any anionic, cationic, nonionic, or zwitterionic surfactant that promotes wetting can be used; in an embodiment, quaternary ammonium chloride surfactants are preferred. The concentration of the surfactant in the treatment solution is at least 0.001% up to 10% by weight.

Another mode of creating stable solutions of water insoluble or sparingly water soluble aldehydes is to use organic co-solvents. Examples of such co-solvents include but are not limited to: methanol, ethanol and acetone. These co-solvents are both good solvents of aldehydes and surfactants. The concentration of co-solvents in the treatment solution is at least 0.001% up to 40% by weight.

Another mode of regulating adsorption and reaction of aldehyde containing treatment is by addition of acid, bases or salts. These can include, but are not limited to: sodium, potassium, and calcium alkalis, sulfuric, phosphoric, phosphorous, phosphonic, hydrochloric, hydrobromic, or hydroiodic acids, and sodium, potassium, and calcium salts such as sulfates, sulfites, persulfate, hydrochloride, phosphate, phosphite, chlorides, bromides, iodides, hypochlorite, chlorite, chlorate, bromate, iodate, or fluoride. Ammonium salts are not recommended as the ammonium group will react with the aldehydes and make less aldehyde available for reacting with the amino groups in the wood. The concentration of acid, alkali or salt in the treatment solution is at least 0.001% up to 10% by weight. These further serve to increase the salinity of the formation and lower the growth of microbes.

Any biocides or fungicides of choice may be added to the aldehyde containing treatment solution. Suitable biocides may include but are not limited to: propiconazole, iodopropylbutylcarbamate, borates, diiodo methyl-p-tolyl sulfone, 2,2 didecyl dimethyl ammonium chloride, methyl 1-(butyl carbamoyl)-2-benzimidazolylcarbamate, chlorophenates, propionates, sorbates, etc. may be used. The concentration of such biocides is per the recommendation of the manufacturers.

In an embodiment, the treatment solution may comprise other functional additives which do not impact the cross-linking activity of the aldehyde but provide other improvements to the wood. These functional additives may comprise pH buffers, adhesives, iron stain inhibitors, corrosion inhibitors, emulsifiers, fillers, viscosity regulators, binders, tackifiers, or combinations thereof.

Organic co-solvents for water miscible aldehydes are useful in treating mixtures only if they increase the wettability of the wood to be treated. There is no minimum or maximum amount of organic co-solvent in the treatment solution that is required. The amount of co-solvent may be determined by adjusting the concentration to permit forming a solution of hydrophobic aldehydes.

One object of the invention is to provide an aldehyde treated wood by altering the wood pores with the cross-linked amino groups with the aldehydes. The aldehydes can include but are not limited to: alkyl aldehydes such as formaldehyde, acetaldehyde, propionaldehyde; alkyl dialdehydes such as glyoxal or glutaraldehyde; aromatic aldehydes such as benzaldehyde, p-hydroxybenzaldehyde, cinnamaldehyde, etc. The concentration of the aldehyde in the treatment solution is at least 0.01% and as much as 10% by weight. The aldehyde may be provided in the form of an acetal or a bisulfite adduct, where in turn, these compounds will produce the required aldehyde in situ.

Another object of the invention is to provide an aldehyde treated wood having improved properties such as dimensional stability, decay and weather resistance. According to the present invention, the foregoing and other objects are attained by a product, method and uses thereof as disclosed in the patent claims.

In one embodiment of this invention, there is provided an aldehyde treated wood, characterized by wood impregnated with an aldehyde mixture containing at least water.

In another embodiment of this invention, there is provided a method for preparing an aldehyde treated wood, characterized in that the wood is impregnated by one impregnation step with a treatment solution containing an aldehyde, water, and at least a surfactant such as didecyldimethylammonium chloride (DDAC), and a salt such as dipotassium phosphite, and a co-solvent such as ethanol, followed by an air drying step. It is noted that said organic co-solvent can be used alone or in combination with at least another co-solvent so long as solubility of all the ingredients in the mixture is maintained.

Any use of the aldehyde treated wood can be provided. However, use as building parts (fascia, cornice, siding, sills, frames, millwork), boat parts (frames, planking, decks), marine items (docks, piers, lobster traps, weir poles), outdoor items (furniture, decks, railings and stairs, walk-ways, boardwalks, playground equipment), bridge parts (beams, railings, decking), railway sleepers, cooling tower slats, utility poles, heavy timbers, fenceposts, stakes, high-way items (guard rail posts, guard rail plates, sign posts, light poles), flooring and containers (tanks, buckets) is preferred.

Brushing, rolling, spraying, soaking or any such process can be used to treat wood with aldehyde containing mixture. Treatment with aldehyde containing mixture can then be followed by an air drying step, a kiln drying step or both. The wood may be dried at a range from ambient (i.e., room) temperature to an upper limit of 200° C.

Times required for all these processes depend upon many factors, including size of wood, species of wood and penetration desired. The treatment method generally used water (from about 5% to nearly 100% based on solution) with proportional amounts of aldehyde, cosolvent, surfactant, salts, biocides, fungicides and other wood treatment agents depending on the desired product loading and material properties.

A general procedure for the dipping process is described below:
i) loading vessel with the treatment formula
ii) dipping the wood completely in the bath,
iii) removing the dipped wood
iv) stacking the wood to dry naturally in an arrangement to expose some or all of the wood surface to air,
v) after sufficient time, typically 2 days to 12 weeks, moving the wood to kilns for drying.

The following examples are presented in further illustration of the invention and are not to be construed as limiting the scope of the invention. Table 1 discloses examples of formulations of treating mixture that have proven successful.

TABLE 1

| | | | Didecyl | | |
|---|---|---|---|---|---|
| | | | dimethyl | | |
| | | | ammonium | | Dipotassium |
| Formula # | Water | Aldehyde | chloride | Isopropanol | phosphite |
| 1 | qs to 100% | 0.26% | 0.05% | 0.0% | 0% |
| 2 | qs to 100% | 0.40% | 0.05% | 10.0% | 0% |
| 3 | qs to 100% | 0.60% | 0.05% | 0.0% | 0.50% |
| 4 | qs to 100% | 0.80% | 0.0% | 0.0% | 0.0% |
| 5 | qs to 100% | 1.00% | 0.05% | 10% | 0.5% |

In these formulations, a large majority of the weight % of treatment solution is co-solvent plus water. All other concentrations of other ingredients are shown in Table 1.

Table 2 shows the results of an experiment in which pieces of fresh sawn wood, referred to as green lumber, were cut with dimensions of 1″×4″×6″, dipped in the solutions, and allowed to air dry for a period of 12 weeks (along with an untreated control piece). Color of the wood as indicated by presence of dark mold on the surface was used as an indicator of successful treatment.

TABLE 2

| Formula | 2 weeks | 4 weeks | 6 weeks | 8 weeks | 10 weeks | 12 weeks |
|---|---|---|---|---|---|---|
| 1 | ND | ND | ND | VSD | SD | SD |
| 2 | ND | ND | ND | ND | VSD | VSD |
| 3 | ND | ND | ND | ND | ND | VSD |
| 4 | ND | ND | ND | ND | ND | VSD |
| 5 | ND | ND | ND | ND | ND | ND |
| Untreated | VSD | SD | SD | D | D | D |

ND = No Discoloration,
VSD = Very Slight Discoloration,
SD = Slight Discoloration,
D = Discolored

In accordance with the present invention, it can be seen from the results presented in Table 2, that an aldehyde containing treatment provides additional protection to the wood.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

1. A method for treating wood comprising:
preparing a treatment mixture comprising a solution or emulsion of:
an aldehyde,
a carrier solvent,
an organic co-solvent,
at least one surfactant, and
at least one acid, base, or salt;
impregnating the wood with the treatment mixture; and
drying the impregnated wood in ambient air or a kiln.

2. The method of claim 1, wherein the aldehyde comprises formaldehyde, acetaldehyde, propionaldehyde, an alkyl dialdehyde, an aromatic aldehyde, or combinations thereof, present in the treatment mixture between 0.01 wt % and 10 wt %.

3. The method of claim 1, wherein the carrier solvent comprises water.

4. The method of claim 1, wherein the organic co-solvent comprises an alcohol, an acetone, or combinations thereof, present in the treatment mixture between 0.001 wt % and 40 wt %.

5. The method of claim 1, wherein the at least one surfactant comprises an anionic surfactant, anionic surfactant, anionic surfactant, zwitterionic surfactant, or combinations thereof, present in the treatment mixture between 0.001 wt % and 10 wt %.

6. The method of claim 1, wherein the at least one acid, base, or salt comprises an acid, wherein the acid comprises sulfuric acid, phosphoric acid, phosphorous acid, hydrochloric acid, hydobromic acid, hydroiodic acid, or combinations thereof, and is present in the treatment mixture between 0.001 wt % and 10 wt %.

7. The method of claim 1, wherein the at least one acid, base, or salt comprises a base, wherein the base comprises a sodium-bearing alkaline, a potassium-bearing alkaline, a calcium-bearing alkaline, or combinations thereof, and is present in the treatment mixture between 0.001 wt % and 10 wt %.

8. The method of claim 1, wherein the at least one acid, base, or salt comprises a salt, wherein the salt comprises a cation of sodium, potassium, or calcium, and an anion of sulfate, sulfite, persulfate, hydrochloride, phosphate, phosphite, chloride, bromide, iodide, hypochlorite, chlorite, chlorate, bromate, iodate, or fluoride, and the salt is present in the treatment mixture between 0.001 wt % and 10 wt %.

9. The method of claim 1, wherein the treatment mixture further comprises a biocide, wherein the biocide comprises propiconazole, iodopropylbutylcarbamate, borate, diiodomethyl-p-tolyl sulfone, 22-didecyl dimethyl ammonium chloride, methyl 1-(butylcarbamoyl)-2-benzimidazolylcarbamate, chlorophenate, propionate, sorbate, or combinations thereof.

10. The method of claim 1, further comprising a functional additive, wherein the functional additive comprises a pH buffer, adhesive, iron stain inhibitor, corrosion inhibitor, emulsifier, filler, viscosity regulator, binder, tackifier, or combinations thereof.

11. The method of claim 1, wherein the step of drying the impregnated wood takes place at 200° C. or below.

12. The method of claim 1, wherein the step of impregnating the wood comprises submerging the wood in a bath or a dip tank containing the treatment mixture.

13. The method of claim 1, wherein the step of impregnating the wood comprises spraying or brushing the treatment solution onto the wood.

14. The method of claim 2, where the aldehyde comprises an aldehyde-producing precursor, wherein the aldehyde-producing precursor is an acetal or bisulfate adduct which converts to aldehyde in situ.
